(19) United States
(12) Patent Application Publication
(10) Pub. No.: US 2008/0204771 A1
(43) Pub. Date: Aug. 28, 2008

(54) CONTINUOUS CALIBRATION OF PROOF PRINTER

(76) Inventors: Andreas M. Albat, Delata (CA); Richard R. Bielak, Port Coquitlam (CA); Bruce F. Milton, Vancouver (CA); Jennifer L. Canonayon, Surrey (CA)

Correspondence Address: Patent Legal Staff;Eastman Kodak Company, 343 State Street, Rochester, NY, 14650-2201, US

(21) Appl. No.: 11/677,603

(22) Filed: Feb. 22, 2007

(51) Int. Cl. H04N 1/00

(52) U.S. Cl. 358/1.9

(57) ABSTRACT

A method for printing includes sending first image file data (160) and color target data (32) to a printing system (5) comprising a printer (7), a color measurement device and a controller (90). A first document (190) including a first image and at least one color patch (30) based on the first image file data and the color target data is sent to the printer. Measuring the color patch is measured to obtain an output color and a color difference between the output color and a goal output color is determined. A second image file data is sent to the controller. The second image file data is changed based on the color difference. A second document comprising a second image is printed, and a plurality of copies of a third document comprising the second image are printed.

### FIELD OF THE INVENTION

The present invention relates to a proof printing adjustment system and method. In particular, the present invention relates to a system and method to automatically calibrate a proof printing system.

### BACKGROUND OF THE INVENTION

It is common to provide a sample of an image to a customer for approval prior to printing a large number of copies of an image using a high volume output device such as a printing press. The sample image is known as a “proof.” The proof is used to ensure that the consumer is satisfied with, among other things, a color of the image.

It is not, however, cost effective to print the proof using high volume output devices of the type used to print large quantities of the image. This is because it is expensive to set up high volume output devices to print the image. Accordingly, it has become a practice in the printing industry to use digital color printers to print proofs. Digital color printers render color prints of images that have been encoded in the form of digital data. This data includes code values indicating the colors to be printed in the image. When the color printer generates a printed output of an image, it is intended that the image recorded on the printed output will contain the exact colors called for by the code values in the digitally encoded data.

In practice, it has been found that colors printed by digital color printers do not always match colors printed by high volume output devices. One reason for this is that variations in ink, paper and printing conditions can cause the digital color printer to generate images with colors that do not match the colors produced by the high volume output device using the same values. Therefore, a proof printed by the digital color printer may not have colors that match the colors printed by the high volume output device.

Accordingly, digital color printers have been developed that can be color adjusted and color confirmed so that they can mimic the performance of high volume output devices. Such adjustable color printers are known in the industry as “proofers.” Two types of adjustments are commonly applied to cause proofers to produce visually accurate proofs of an image, namely color confirmation and color calibration adjustments. Color confirmation ensures that a desired final color output from the proofer is actually achieved, as specified by industry standards or customer requirements.

Color calibration adjustments are used to modify the operation of the proofer so that the proofer prints the colors called for in the code values of the images to be printed by the proofer. These adjustments are necessary to compensate for the variations in ink, paper, and printing conditions that can cause the colors printed by the proofer to vary from the colors called for in the code values. To determine what color calibration adjustments must be made, it is necessary to determine how the proofer translates code values into colors on the printed image. This is done by asking the proofer to print a calibration test image or so-called “color target.” The calibration test image includes a number of color patches. Each color patch contains the color printed by the proofer in response to a particular code value.

Typically, a manual stand-alone calibration device is used to measure the colors in the test image. The measured color of each color patch is converted into a color code value and is compared against the original “color target” code value associated with that patch. Thereafter, comparisons are used to determine what adjustments must be made to the proofer to cause the proofer to print the desired colors in response to the particular color code values.

Color management adjustments are used to modify the operation of the proofer so that the image printed by the proofer will have an appearance that matches the appearance of the same image as printed by the high volume output device. The first step in color management is to determine how the high volume output device converts color code values into printed colors. This is known as “characterization.” The result of such a characterization process is a “color profile.” To characterize the high volume output device and produce the color profile, it is necessary to obtain a characterization test image. The characterization test image can be printed by the high volume output device. However, if it is known that the high volume output device converts code values into printed colors in accordance with industry standards, such as FOGRA (Graphic Technology Research Association standard (www.fogra.org)) and SWOP (Specifications for Web Offset Printing), then the test image printed in accordance with that standard can be used for characterization purposes.

It is recognized that both calibration and color confirmation adjustments are based upon objective measurements of the color and tone characteristics of test images printed by the proofer and high volume output device. The most accurate device for measuring color for calibration and confirmation purposes is the spectrophotometer. The spectrophotometer measures the reflectance and/or transmittance of an object at a number of wavelengths throughout the visible spectrum. More specifically, the spectrophotometer exposes a test image to a known light source and then analyzes the light that is reflected by the test image to determine the spectral intensity. A typical spectrophotometer is capable of measuring a group of pixels in an image. It includes an apparatus that measures the light that is reflected by a portion of an image at a number of wavelengths throughout the visible spectrum to obtain data that represents the true spectral content of the reflected light.

The use of such stand-alone spectrophotometers for proofing is very costly. Part of this cost is created by the inherent redundancy of many of the systems used in those devices. For example, a stand-alone spectrophotometer has an “X-Y” table to move the test image relative to the spectrophotometer. A digital color printer or proofer also contains an “X-Y” displacement mechanism for moving the paper and printing element or printhead. Similarly, both the spectrophotometer and the proofer contain separate electrical control systems, motors and other components. Thus, the total cost of the proofing system, including a separate stand-alone spectrophotometer and a proofer, is very high.

Installation and maintenance costs are also high because two separate devices, typically manufactured by different vendors, must be separately purchased, installed, and maintained. Various makes and models of spectrophotometers are used for color management and, since there is significant measurement bias between devices, considerable measurement variability results. Finally, there is a significant labor cost associated with making calibration and color management adjustments to the proofer using a stand-alone spectrophotometer. Accordingly, there are substantial cost and efficiency penalties associated with stand-alone proofing combinations.

Currently most proofing systems that utilize wide format inkjet printers, employ calibration technologies to ensure that a given inkjet printer produces output colors that closely match defined goal colors. It is thereby ensured that a plurality of printers of the same type will reproduce the goal colors quite closely. Many commercial proofing calibration implementations use the common approach of calibrating at certain times, e.g. Monday mornings or upon failure. Some software packages offer automated execution based on scheduling. This approach has the fundamental disadvantage that color can drift or change significantly between calibrations. Furthermore, if an unrepresentative print is used as the input for calibration routine, it may result in skewing the color output to undesired values. This undesirable shift could only be identified by verifying the output of a calibrated printer against the goal colors. Automated calibration with built-in spectrophotometers is prone to another problem. Since no user intervention is required to verify the image quality of the calibration target, the automated process may result in the use a proof containing banding.

In general inkjet printers do not produce perfect proof-to-proof color consistency results. In addition to short term noisy behavior, slow drifting and step color shifts also occur due to environmental changes such as temperature or humidity, ink variations due to, for example lot variation, media changes due to, for example, lot-to-lot variability, and hardware changes such as print head replacement.

The performance variation of inkjet printers is also typically not tracked. The absence of such data makes it difficult to establish routines for adjusting the printer, or the data sent to the printer, so as to render colors more consistently.

Furthermore the current calibration embodiments from software vendors still require ongoing manual interventions to perform and monitor the state of the printing system and identify when the calibration should be redone.

Recently an increasing number of wide-format inkjet printers offer built-in spectrophotometers, which provide sufficiently accurate color measurements to allow the printers to be used as proofing systems. Examples of such systems include the B2 printer from Dupont-Nemours, the Veris system from Kodak, and the Z2100 and Z3100 systems from Hewlett-Packard. These devices lend themselves to better automation and reduced user intervention. In addition, different vendors now offer software packages supporting calibration of the printer with the built-in spectrophotometer as well as verification of color output and support for the measurement of color profiling targets.

Most proofing software vendors, as well as spectrophotometer manufacturers offer solutions which allow measurement of custom or standard targets, such as the Fogra Media Wedge, to ensure that each proof meets a certain proofing standard.

Some printing presses are equipped with monitoring devices to automatically adjust the inking in specific zones to maintain the correct ink coverage. This type of feedback system directly controls the ink settings of the actual printing apparatus.

Some manufacturers, such as Hewlett-Packard, have measuring devices, such as calorimeters, built into their printers. More recently these manufacturers have also built spectrophotometers into their printers. The built-in measuring devices allowed automated calibration upon start-up of the system.

Against this background there is a clear need for automatically calibrating a proofing printer on a reliable basis.

### SUMMARY OF THE INVENTION

Briefly, according to one aspect of the present invention a method for printing comprises: sending to a printing system comprising a printer, a color measurement device and a controller first image file data and color target data; printing with the printer a first document based on the first image file data and the color target data, the first document comprising a first image and at least one color patch; measuring on the first document the at least one color patch with the color measurement device to obtain an output color for the color patch; determining the color difference between the output color and a goal output color; sending to the controller second image file data; changing the second image file data based on the color difference; printing with the printer a second document, the second document comprising a second image, and printing a plurality of copies of a third document comprising the second image.

The invention and its objects and advantages will become more apparent in the detailed description of the preferred embodiment presented below.

### BRIEF DESCRIPTION OF THE DRAWINGS

The present invention will be more readily understood from the detailed description of exemplary embodiments presented below considered in conjunction with the attached drawing:

FIG. 1 shows a block diagram of a proof printing system with an integrated spectrophotometer. It is to be understood that the drawing is for purposes of illustrating the concepts of the invention and may not be to scale;

FIG. 2 shows a flow chart that describes how many documents are printed, but the color patches on only a fraction of them are color-measured, the measurement occurring with frequency F;

FIG. 3 shows a flow chart describing how the color target on a series of documents, each color target containing a subset of color patches, may be varied cyclically so that an entire set of ideally preferred color patches can be addressed when the cycle is completed, each individual document with its associated color target contributing partially to the full set of ideally preferred color patches;

FIG. 4 shows a flow chart describing how the color-measurements on document m, together with previously acquired data, is used to modify the image color data to be printed in subsequent document m+1;

FIG. 5 shows a flow chart describing how the color-measurements are first performed on a number of documents having color patches, before the collected data is used to modify the image color data to be printed in a subsequent document;

FIG. 6 shows a flow chart describing how the measurement cycle of FIG. 5 is repeated a number of times, and the data so collected is then used to make a color data correction for later documents; and

FIG. 7 shows a flow chart describing how certain subsets of patches can be measured multiple times on a series of documents, while another subset of color patches is measured a different number of times. The particular example is that of the subset of overprints of the colors C, M, Y and K forming one subset, and the colors C, M, Y and K forming the other subset.

### DETAILED DESCRIPTION OF THE INVENTION

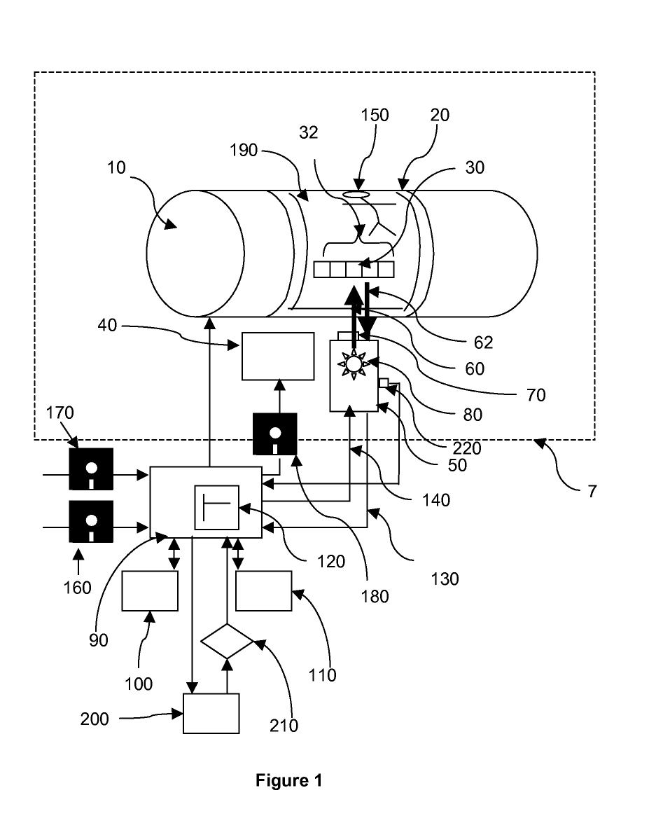

Referring to FIG. 1, a printing system 5 of the present invention is illustrated. Printing system 5 includes a printer 7, a controller 90 coupled to the printer 7, an optional humidity sensor 100 coupled to the controller 90 and an optional ambient temperature sensor 110 coupled to the controller 90. Printer 7 is preferably a commercial printer and has a spectrophotometer 50 integrated with it. Drum 10 is internal to printer 7. Drum 10 and a print head 40 are coupled to the controller 90. The spectrophotometer 50, which contains an illumination source 80, is coupled to the controller 90 via spectrophotometer control line 140. Controller 90 is programmed with control program 120. An ultraviolet (UV) filter 70 is coupled to the spectrophotometer 50. A substrate 20 is coupled to the drum 10 and a color target 32 containing color patch 30 (which is one of one or more color patches that form color target 32) is printed on substrate 20. Drum 10 is preferably a printer drum; however, it may also be a platen or any other suitable type of printing support surface. Spectrophotometer temperature sensor 220 is located in or on spectrophotometer 50 and is coupled to controller 90.

In operation, the print head 40 prints the color patch 30 on the substrate 20; spectrophotometer 50 illuminates color patch 30 with an incident light 60, preferably with the UV filter 70 in the path of the incident light 60, measures a reflected light 62, and assigns a numerical color value to the color measured in the reflected light 62; and the controller 90 receives the numerical color value determined by the spectrophotometer 50 via output signal 130, whether analog, digital or the like. Controller 90 can optionally adjust the numerical color value in order to compensate for the color drift of spectrophotometer 50 due to change in temperature during operation. In order to obtain stable measurement results, the actual measurement by spectrophotometer 50 can be performed multiple times. The printer 7 is controlled by the controller 90.

The controller 90 is configured to adjust output signal 130 based on measurement conditions and printing conditions, as addressed below. The optional humidity sensor 100 and optional ambient temperature sensor 110 provide the controller 90 with the ability to determine the humidity and the ambient temperature, respectively, at times selected by the controller 90. These times can include, but are not limited to, the time when printing happens and the time when the spectrophotometer 50 measures the color of the color patch 30. The controller 90 may also perform one or more of the following functions (a) adjust the output signal 130 of the spectrophotometer 50 to compensate for a color of backing, which is preferably the color of drum 10, under the substrate 20, (b) adjust the output signal 130 of the spectrophotometer 50 to compensate for the presence or absence of the UV filter 70 in path of the incident light 60 and (c) adjust the output signal 130 of the spectrophotometer 50 based on a reference color standard traceable to one of a United States national and/or international standards authority.

When the color patch 30 is printed on the substrate 20, the color of color patch 30 changes as it dries. It can take over a day for the color patch 30 to completely dry. A criterion is set for the maximum allowable variation in color that will be allowed from the color patch 30, known as a “color tolerance.” A sufficient number N of color patches are chosen to ensure that particular print jobs are printing within the allowable color tolerance. This number can vary with the specific kind of printer used. Typically, 81 color patches are employed for calibrating a CMYK printer. Color patch 30 is measured as shortly as practically possible after printing the color patch 30 on the substrate 20, while the substrate 20 is still on the drum 10, thereby allowing color accuracy to be confirmed for the color patch 30. The method by which controller 90 modifies output signal 130 to obviate the time-consuming process of waiting for the ink to dry is described fully in commonly-assigned copending U.S. patent application Ser. No. 11/429,087 entitled “A proof Printing Adjustment System and Method” filed May 5, 2006, the complete specification of which is hereby incorporated in here full.

The method of the present invention comprises sending image file data 160 and, optionally, color target data 170 to controller 90 of printing system 5, color target data 170 comprising color data for at least one color patch. Controller 90 then combines image file data 160 and, optionally, color target file data 170 into a document image file 180. Document image file 180 is then provided to print head 40 of printer 7 for printing on substrate 20 in the form of document 190, document 190 comprising printed image 150 and, optionally, printed color target 32, color target 32 comprising at least one color patch 30. Spectrophotometer 50 then measures the at least one color patch 30 of color target 32 to obtain output colors for the color patches in color target 32, and sends output signal 130, representing this color data, to controller 90. In preparing to print a later document, controller 90 then modifies the image file data of the later image to be printed on that later document, the modification being based on the measurement performed above.

Printing the calibration target with images 150 has the advantage that the system performance can be continuously monitored. Recently more printers, especially wide format inkjet printers, are being equipped with built-in spectrophotometers. These spectrophotometers have sufficient color measurement accuracy to allow their output to be used as input into calibration routines to maintain consistent color output of a printer. This performance also allows them to be used in matching the output of two color printers. The ability to measure automatically the color target with every proof allows for widespread adoption of the disclosed method.

In one embodiment of the present invention, the difference between the color data in output signal 130 and goal color data for the color patches in color target 32 of the original document 190 is employed to modify at least the image file data for the later document, and, optionally, also the color target file data for the color patches in the color target of the later document. The relevant goal color for a particular color patch is known from a previous calibration of a printing system of the type of printing system 5, and which is used as a reference system for all printing systems 5.

In one embodiment of the present invention the modification is based specifically on minimizing the difference between the color data in output signal 130 and goal color data for the color patches in color target 32 of the original document 190.

It is to be specifically noted that there is no requirement for the original and later documents to have the same image. Nor is it required for the original and later documents to have the same color patches in their color targets. It is, however, possible to have the images the same and/or the color patches the same.

In one embodiment of the present invention the original and later documents are printed immediately consecutively by printer 7. In a more general case, however, the documents are not necessarily printed immediately consecutively, but can be separated in the sequence by a number of other documents. This is required, for example, in situations where the color corrected document is stored in a queue for printing later in the sequence.

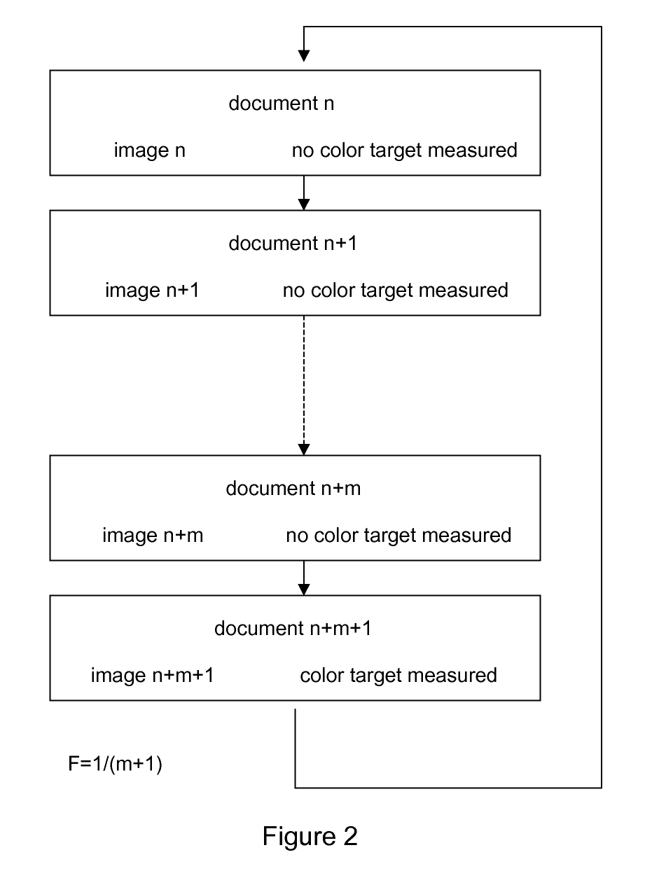

In a further embodiment of the present invention, shown in the flow chart of FIG. 2, color target 32 is printed and measured at a user-specified frequency F on documents 190. The user-specified frequency F is expressed as a fraction of all prints generated by printer 7 on substrates 20 and can vary from zero, at which no color target 32 is ever printed on substrates 20, to 1, at which color target 32 is printed on every substrate 20 printed on printer 7. In a variant of this embodiment, color target 32 is printed at a higher frequency than F, but only measured at frequency F. One example of such a situation occurs when FOGRA or SWOP standard color targets are employed as color target 32, in which case there is a customer demand for the standard target, but the image file data modification (and the optional color patch data modification) performed via the present invention is not required on that high frequency F.

Since most printers exhibit some degree of repeatable color variation across the print, optimum stability may be obtained by always employing a specified location for printing color target 32, though the present invention is not limited to this choice. On the other hand, in order to address this very variation, the position of color target 32 can be varied over the surface of substrate 20 in order to assess this variation. Color target 32 generally consists of color patches 30 printed with the primary ink colorants, e.g. cyan, magenta, yellow and black, additional colorants offered by the printer, e.g. red, green and blue, and typically overprint combinations of these colorants with 2-, 3- and 4-color overprints being most common. Generally diluted inks such as light cyan, light magenta and light black are mixed with the full strength inks when printing the primary ink vectors and are not calibrated independently.

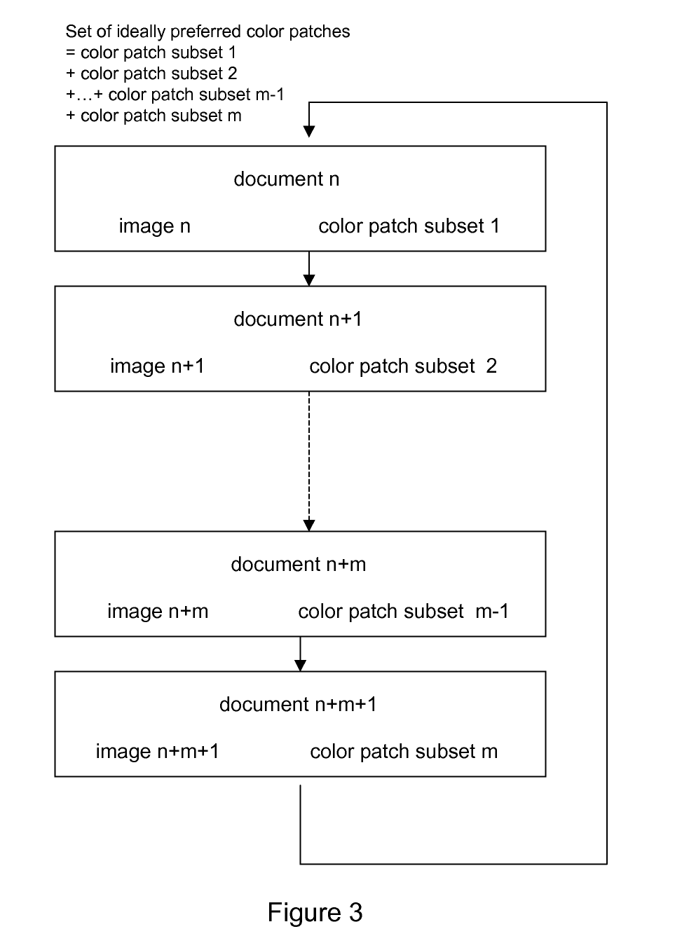

While 81 color patches 30 make up a typical color target 32 for calibrating a CMYK printer, such a number of patches also consume a large amount of space on substrate 20, which also has to accommodate the actual image or images that the user wishes to print. The actual step of spectrophotometer 50 measuring the color of color patch 30 also consumes a finite amount of time. Hence, to reduce the overall size and measurement time of color target 32, color target 32 can be chosen to have a subset of the set of ideally preferred color patches. This is shown in the flow chart in FIG. 3. In this fashion, a first document 190 may accordingly contain a first subset, while later documents can contain color targets 32 having other subsets of the set of ideally preferred color patches. The user can, by this approach, address the entire set of ideally preferred color patches at a predetermined frequency, each document 190 with its associated color target 32 contributing partially to the full color calibration of printer 7.

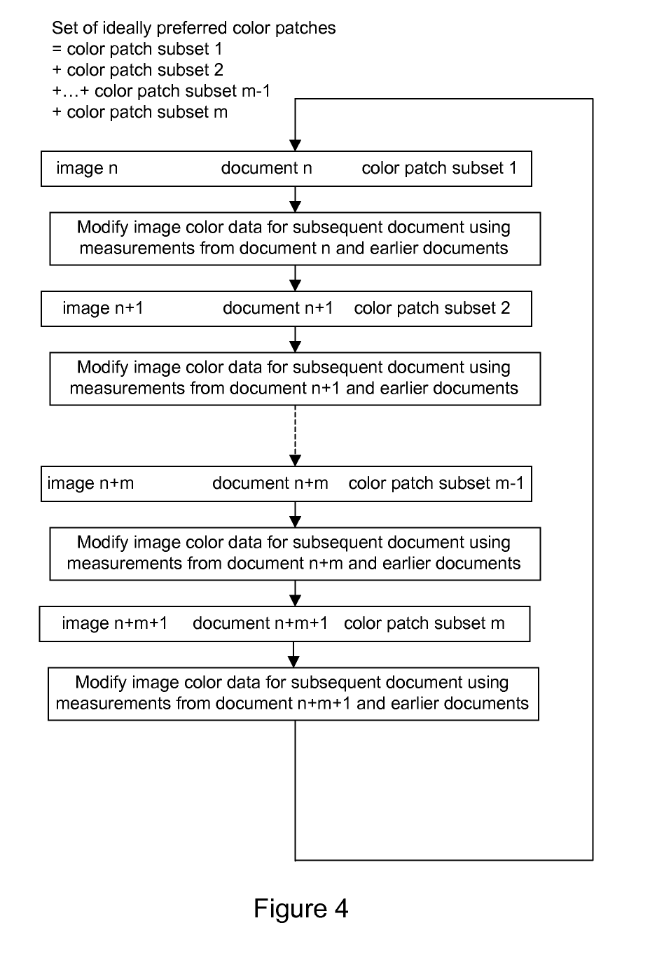

By way of example, the complete color target can have 81 color patches. A first subset of the set of ideally preferred color patches can be chosen to be 41 patches selected from the 81 patches. A second subset of the set of ideally preferred color patches is then chosen to be the 40 remaining patches. Two implementations present themselves. In a first implementation, shown in the flow chart of FIG. 4, the data obtained by measuring the first subset of 41 color patches is used to modify at least the image file data for the next document, and, optionally, also the color target file data for the color patches in the color target of the next document. When this next document, containing its 40 color patches, is printed, the 40 color patches are measured and that data is used to modify the color data for a subsequent document and, optionally, its color patches. Advantage is therefore taken of every set of measurements immediately after it is performed.

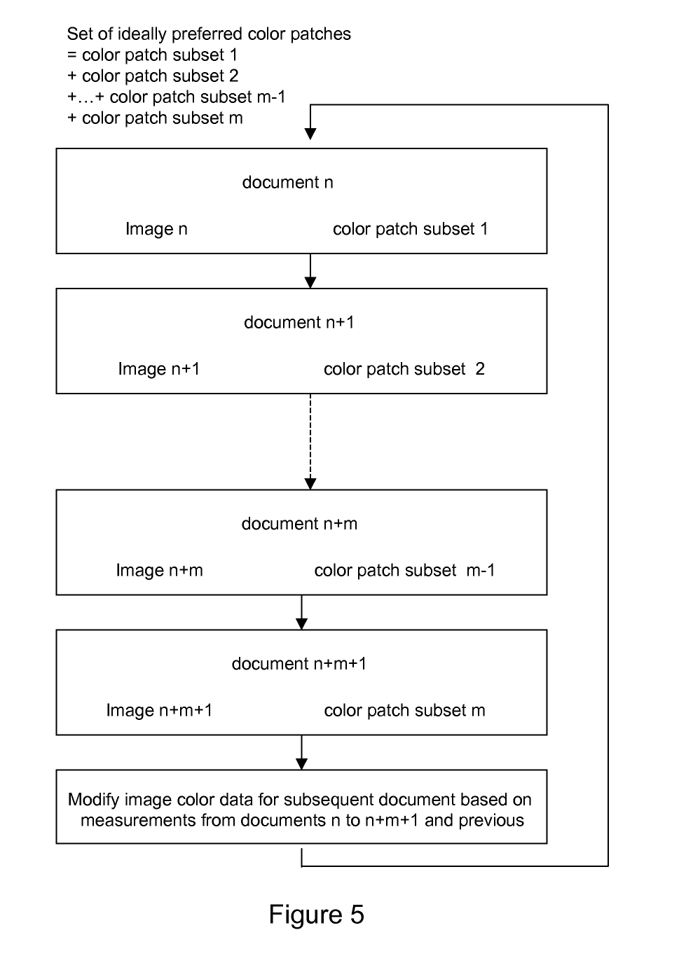

In a second implementation, shown in the flow chart of FIG. 5, the color patches from a document containing the 41 color patches of the first subset are measured and the data so obtained is stored by controller 90. The 40 color patches from the second subset of color patches is then measured, and the data for the two sets of measurements is then combined to determine a required modification for a subsequent document, and optionally, for its color patches. In this implementation, the measurement data for the entire set of 81 patches is first gathered before any color data modification is performed on any subsequent document.

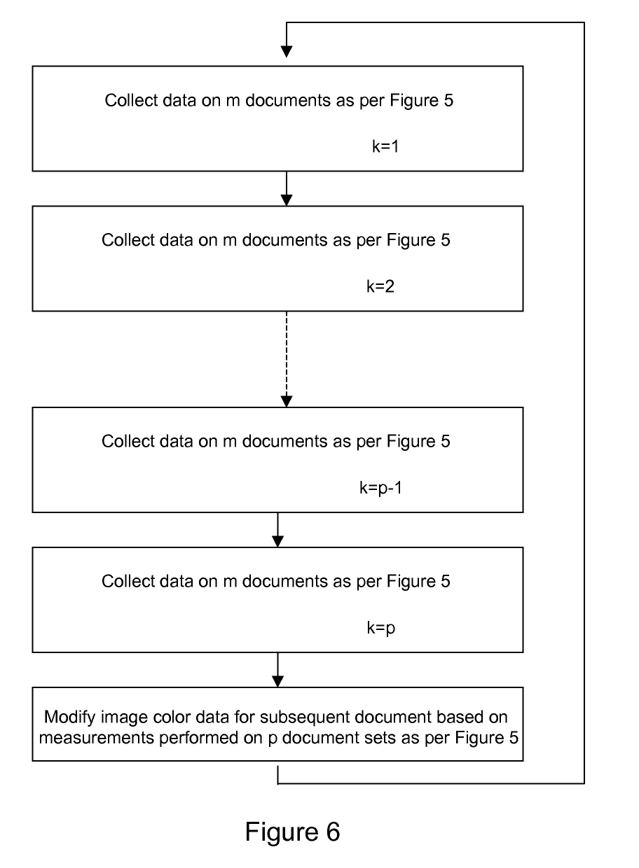

In yet a further implementation of the present invention, the two subsets of color patches are measured multiple times, before any color data modification is performed on any subsequent document. This is shown in a more general form in FIG. 6, where the measurement cycle of FIG. 5 is repeated p times (k being an iteration integer), and the data so collected is then used to make a color data correction for later documents. This embodiment is particularly useful when printer 7 exhibits a color variation across substrate 20. In such a case, the different cycles of measurements are repeated for the different positions of color target 32, and the image data modification is performed based on the data as collected across all such positions.

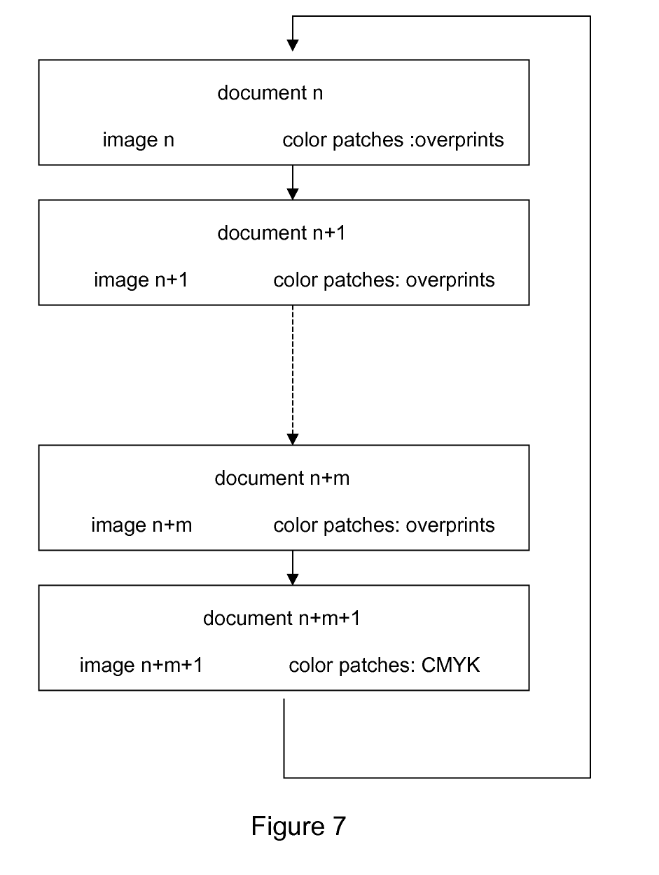

In one embodiment of the present invention, shown in the flow chart of FIG. 7, use is made of the fact that overprints are more sensitive to color variation and drift than patches containing primary ink colorants. In this case a first color patch subset of the set of ideally preferred color patches is comprised of the primary ink colorants, while a second color patch subset is comprised of various overprints of these primary ink colorants. The second color patch subset is printed with greater frequency than the first color patch subset, and then measured as described above.

In a further embodiment of the present invention, a plurality of measurements of a color target, or of a selected subset of color patches, is stored by controller 90 and this data is then filtered appropriately to provide an improved basis for controller 90 on which to decide on a modification of the color data for a subsequent document and, optionally, for its color patches. As measurements continue to be made, this resulting database 200 can be updated. The most recent N measurements (N an integer) can then be used as basis for the decision regarding modification of the color data for subsequent document and, optionally, for its color patches. Filtering the calibration input data, by the use of any suitable filter 210, including but not limited to a software algorithm, allows for different weighting approaches to avoid unnecessarily reacting to random print-to-print color variation, as well as to avoid following the variation in measurement induced by the statistical behavior of the spectrophotometer. This allows the tracking of the slower drift of the printing system induced by such phenomena as, but not limited to, the drift due to slowly changing environmental conditions.

The filtering can allow for step changes where a sudden color shift is expected in the system, such as that caused by replacing a print head. The parameters that can be optimized in filtering the data include, but are not limited to, temperature, humidity, media lot, ink lot, print head replacement, print head cleaning task, nozzle status, alignment tasks such as uni or bi-directional print head alignment and difference between current and goal color. Not all of these states can be readily queried from all printers, but using as much status information as possible allows the best tracking of the average printer behavior.

A key function of filter 210 is outlier detection. Controller 90 can output a user warning message or an error message when a significant step change, not predicted on the basis of the system status and/or the previous color measurement data, is detected in the color measurement data. A likely reason for such a change is a failed inkjet nozzle. This warning allows the operator of printing system 5 to attend to the failed nozzle.

To better correlate the proofing results with those of an actual volume printing press, color patches conforming to one of the international standards such as SWOP or FOGRA, can be printed at selected times or at a selected frequency. In the case where such standard FOGRA or SWOP color targets 32 are used, the color patches 30 are color managed to reflect the device-independent color difference between, for example, a CMYK value printed on the press and the same CMYK value as printed on printing system 5. As a result the goal color when using such standards, is not equal to the goal color specified by the relevant standards authority, but is, instead, derived from the color transformation between the relevant volume press and printing system 5. Only in vary rare cases might the FOGRA-specified Lab color, for example, be equal to the goal color derived from the relevant FOGRA-patch via the press-to-printing system 5 transformation. In proofing it is customary to employ, for example, 46 color control points out of the complete color characterization of the standard. The approach of adding the international standard color patches, or subsets of them, at some frequency, ensures optimum color consistency at the selected 46 color control points. The use of these specific international standard color patches can be combined with any one of the previously described embodiments of the present invention.

In a further aspect of the present invention a later document that has benefited from the correction of image file data as described herein, can have printed upon it not only color target 32, in its uncorrected form, but also a color corrected copy of color target 32, the color corrected copy being corrected by the method of the invention. This allows the operator of printing system 5 feedback on the performance of the color correction.

In a further aspect the method of the present invention includes the step of printing the measurement results of color target 32 on substrate 20. Measurement results can include, but are not limited to, average and maximum color difference between the goal color and measured color. This is to be contrasted with the typical label approach employed in the prior art.

To the extent that the method described here is particularly useful in proofing, the proofs so produced can be used to compare against a plurality of printed documents comprising at least one of image 150 and the image of the later document, the printed documents being printed on a volume printer. In this respect printer 7 can be used, if so required, as the volume printer of the present invention.

The overall advantage of the method of the present invention is that the printing system 5 provides consistent color without user intervention.

The invention has been described in detail with particular reference to certain preferred embodiments thereof, but it will be understood that variations and modifications can be effected within the scope of the invention.

### PARTS LIST

5 printing system
7 printer
10 drum
20 substrate
30 color patch
32 color target
40 print head
50 spectrophotometer
60 incident light
70 ultraviolet (UV) filter
80 illumination source
90 controller
100 humidity sensor
110 ambient temperature sensor
120 control program
130 output signal
140 spectrophotometer control line
150 images
160 image file data
170 color target data
180 document image file
190 original document
200 resulting database
210 filter
220 spectrophotometer temperature sensor

1. A method for printing, the method comprising:
a) sending to a printing system comprising a printer, a color measurement device and a controller first image file data and color target data;
b) printing with the printer a first document based on the first image file data and the color target data, the first document comprising a first image and at least one color patch;
c) measuring on the first document the at least one color patch with the color measurement device to obtain an output color for the color patch;
d) determining a color difference between the output color and a goal output color;
e) sending to the controller a second image file data;
f) changing the second image file data based on the color difference;
g) printing with the printer a second document, the second document comprising a second image, and
h) printing a plurality of copies of a third document comprising the second image.

2. A method for printing, the method comprising:
a) sending to a printing system comprising a printer, a color measurement device and a controller first image file data and color target data;
b) printing with the printer a first document based on the first image file data and the color target data, the first document comprising a first image and at least one first color patch;
c) measuring on the first document the at least one first color patch with the color measurement device to obtain a first output color for the at least one first color patch;
d) determining a color difference between the output color and a goal output color;
e) sending to the controller a second image file data comprising a second image and at least one second color patch;
f) changing the second image file data based on the color difference;
g) printing with the printer a second document, the second document comprising a second image and at least one second color patch;
h) measuring on the second document the at least one second color patch with the color measurement device to obtain a second output color for the at least one second color patch; and
i) modifying the color calibration of the controller based on the first output color and the second output color.

3. The method of claim 2 wherein the first image and the second image are different images.

4. The method of claim 2 wherein printing the second document is the next document printed by the printer after the first document.

5. The method of claim 2 wherein the modifying the color calibration is based on:
a) the color difference between the first output color and a goal color; and
b) the color difference between the second output color and the goal color.

6. The method of claim 2 wherein the measuring device is one of a spectrophotometer, a calorimeter and a densitometer.

7. A method of printing comprising:
a) printing a first printing proof with a proof printer, the first printing proof comprising an image area containing a first image and at least one first color patch;
b) measuring the at least one first color patch with a color measurement device to obtain a first output color for the color patch;
c) changing a color calibration of the proof printer to minimize a color difference between the first output color and a goal output color;
d) printing a second printing proof with the proof printer, the second printing proof comprising an image area containing a second image and at least one second color patch;
e) measuring the at least one second color patch with the color measurement device to obtain a second output color for the at least one second color patch; and
f) modifying the color calibration of the proof printer, using the first output color and the second output color to minimize a color difference between the second output color and the goal output color.
